(19) United States
(12) Patent Application Publication
(10) Pub. No.: US 2008/0002838 A1
(43) Pub. Date: Jan. 3, 2008

(54) SYSTEMS AND METHODS FOR NOISE REDUCTION IN AUDIO AND VIDEO COMPONENTS

(76) Inventor: Michael Pyle, Draper, UT (US)

Correspondence Address: BAKER & ASSOCIATES PLLC, 470 EAST NINTH AVENUE, SALT LAKE CITY, UT, 84103, US

(21) Appl. No.: 11/770,084

(22) Filed: Jun. 28, 2007

Related U.S. Application Data
(60) Provisional application No. 60/806,237, filed on Jun. 29, 2006.

(51) Int. Cl. H04B 15/00

(52) U.S. Cl. 381/94.1

(57) ABSTRACT

One embodiment of the present invention relates to a noise containment and vibration isolation system for integrated audio/video electrical components. The system includes a housing, an inlet, an outlet, an electrical component board, a noise containment system, and a mechanical isolation system. The noise containment system includes encasement of the electrical component board and baffling of the inlet and outlet air vents. Noise containment obstructs direct ambient air flow paths within the housing, thereby also impeding and obstructing the transmission path of air-based sound waves. The mechanical isolation system includes positioning dampening members between the housing and the electrical component board. The mechanical isolation system further includes positioning a dampening member between the housing and a supporting surface. Mechanical isolation minimizes the transmission of vibration-based sound waves between mechanical coupling points. The combined use of noise containment and component isolation significantly reduces noise transmission of the system, thereby increasing sensitive audio and/or video functionality of the electrical component board.

### RELATED APPLICATIONS

This application claims priority to U.S. provisional application Ser. No. 60/806,237 filed Jun. 29, 2006, the contents of which are incorporated by reference.

### FIELD OF THE INVENTION

The invention generally relates to systems and methods for noise reduction. In particular, the invention relates to systems and methods for minimizing audible noise produced by audio and video components.

### BACKGROUND OF THE INVENTION

Audio and video components are designed to convert electrical signals into either audio or video outputs in order to convey information to a user for purposes of entertainment or communication. For example, a television converts an electrical input signal into a visual image and a corresponding audible output. Improvements in technology have increased the performance of these devices so as to produce higher quality outputs. The quality of an audio or video output may be defined by the clarity or amount of undesirable signal present in the output. For example, a high quality audio output will include a minimal amount of audible noise such as static, crosstalk, etc. Likewise, a high quality video image will include a minimal amount of visual noise such as stray images, color patterns, distortion, etc.

Home entertainment has evolved from separate audio and video components to integrated multi-component systems that are used to maximize performance. For example, audio systems are designed to produce a relatively high level of audio output for purposes of listening to music or other types of audio information. Whereas, video components typically include the ability to produce both audio and video outputs. However, the audio systems of most video components generally produce a lower quality output than a corresponding dedicated audio component. Therefore, components have been developed to couple with one another so as to increase performance or provide additional functionality. Various components are commonly electrically coupled together including video output devices, audio output devices, video input devices, audio input devices, networking devices, etc.

Modern presentations utilize audio and visual information to assist in communicating concepts in an effective and efficient manner. For example, presenters often utilize Powerpoint™ presentations to include visual information that assists in communicating concepts during a presentation. Presentations may also include media clips or audio recordings. As with home entertainment, higher quality audio and video is preferable to effectively convey concepts or entertain an audience during presentations.

The performance, reliability, and/or quality level of audio and video components is affected by a multitude of variables and characteristics. Advances in electrical technology alone do not necessarily solve certain performance problems with respect to audio and video components. For example, the quality of video produced by a video output component will be significantly affected by a power supply that includes an abundance of electrical abnormalities regardless of the video technology included in the particular video output device. It is also necessary for components to operate and intercouple with one another in a simplified, seamless and reliable manner so as to be utilized to the full potential. Therefore, there is a need in the industry for systems and methods of increasing audio and video performance by incorporating technologies that maximize performance characteristics. In addition, there is a need in the industry for systems and methods that allow users to more effectively utilize audio and video components, including integration, interfaces, and operational systems.

### SUMMARY OF THE INVENTION

Embodiments of the present invention relate to systems and methods for minimizing noise transmission in audio and/or video components. One embodiment of the present invention relates to a noise containment and vibration isolation system for integrated audio/video electrical components. The system includes a housing, an inlet, an outlet, an electrical component board, a noise containment system, and a mechanical isolation system. The noise containment system includes encasement of the electrical component board and baffling of the inlet and outlet air vents. Noise containment obstructs direct ambient air flow paths within the housing, thereby also impeding and obstructing the transmission path of air-based sound waves. The mechanical isolation system includes positioning dampening members between the housing and the electrical component board. The mechanical isolation system further includes positioning a dampening member between the housing and a supporting surface. Mechanical isolation minimizes the transmission of vibration-based sound waves between mechanical coupling points. The combined use of noise containment and component isolation significantly reduces noise transmission of the system, thereby increasing sensitive audio and/or video functionality of the electrical component board. A second embodiment of the present invention relates to a method for noise containment and vibration isolation of integrated audio/video electrical components.

Conventional audio and video systems often generate external audible noise during use, thereby reducing the overall audio quality or performance. These systems generally include electrical boards mechanically mounted directly to a housing, which allow external vibrations to electrically affect the electrical components and internal vibrations to be directly transmitted to the housing. Likewise, most audio systems include some form of optical media reading component that utilizes a motor to spin a specifically sized optically readable media. The audible noise produced by the motor also diminishes the audio output quality of the particular system. In addition, conventional electrical systems often include air flow or cooling systems that cause audible noise or internal vibrations. The systems and methods of the present invention overcome these problems by utilizing combined mechanical isolation and noise containment systems to minimize the affects of noise on an audio and or video system.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular—rather than complete—portions of the systems and methods of making and using the system according to the invention. In the Figures, the physical dimensions may be exaggerated for clarity. The figure numbers corresponded to the respective page number.

FIG. 1 illustrates an exploded perspective view of a noise containment and vibration isolation system in accordance with one embodiment of the present invention;

FIG. 2 illustrates a schematic view of the embodiment illustrated in FIG. 1 further illustrating the noise containment and mechanical isolation systems;

FIG. 3A illustrates a detailed perspective view of the plenum illustrated in FIG. 1;

FIG. 3B illustrates a detailed elevational view of an alternative plenum for use in a noise containment and vibration isolation system such as the embodiment illustrated in FIG. 1;

FIGS. 4A-4C illustrate a perspective, profile, and bottom views of an outlet for use in a noise containment system such as the embodiment illustrated in FIG. 1;

FIG. 5 illustrates a detailed perspective view of a mechanical isolation coupling between a housing and electrical component board for use in a vibration isolation system such as the embodiment illustrated in FIG. 1;

FIG. 6 illustrates a profile view of an isolation member for use in association with a vibration isolation system such as the embodiment illustrated in FIG. 1; and

FIG. 7 illustrates a flow chart of a method for noise containment and vibration isolation of integrated audio/video electrical components in accordance with a second embodiment of the present invention.

### DETAILED DESCRIPTION OF THE INVENTION

Embodiments of the present invention relate to systems and methods for minimizing noise transmission in audio and/or video components. One embodiment of the present invention relates to a noise containment and vibration isolation system for integrated audio/video electrical components. The system includes a housing, an inlet, an outlet, an electrical component board, a noise containment system, and a mechanical isolation system. The noise containment system includes encasement of the electrical component board and baffling of the inlet and outlet air vents. Noise containment obstructs direct ambient air flow paths within the housing, thereby also impeding and obstructing the transmission path of air-based sound waves. The mechanical isolation system includes positioning dampening members between the housing and the electrical component board. The mechanical isolation system further includes positioning a dampening member between the housing and a supporting surface. Mechanical isolation minimizes the transmission of vibration-based sound waves between mechanical coupling points. The combined use of noise containment and component isolation significantly reduces noise transmission of the system, thereby increasing sensitive audio and/or video functionality of the electrical component board. A second embodiment of the present invention relates to a method for noise containment and vibration isolation of integrated audio/video electrical components. Various other well known noise reduction systems or methods may be incorporated or combined with embodiments of the present invention to further increase the noise reduction performance of a particular system or method.

The following terms are defined for purposes of utilization throughout this application:

Mechanical Coupling—A physical coupling or support system between two objects. For example, an electrical component board may be mechanically coupled to a housing without necessarily electrically or vibrationally coupling the electrical component board to the housing. A mechanical coupling may also include supporting an object.

Isolation—For purposes of this application, the term isolation is defined as substantial vibrational mechanical isolation between two mechanically coupled components. Standard mechanical couplings are generally vibrationally coupled (not isolated) in that a vibration in one object can easily propagate across the mechanical coupling to the other. For example, an unbalanced vehicle tire causes vibrations which propagate to the frame and chassis causing the entire vehicle to vibrate because the coupling between the tire and the vehicle is vibrationally coupled.

Dampening—The absorption of mechanical vibrations. For example, a dampening member may be a rubber gasket that absorbs vibrations between a nut and bolt coupling.

Ambient air transmission—The flow/circulation of external (ambient) air into substantially enclosed/encased region. For example, the cycle of air flowing into and out off an internally encased chassis of electrical components. “Direct ambient air transmission” is specifically defined in this application as a straight linear air flow path between the external/ambient region and the internal/encased region.

Baffle—An obstruction causing redirection. A baffle may be used acoustically to block direct ambient air transmission so as to force ambient air to flow around it. This redirecting has the acoustic affect of containing noise and minimizing noise transmission without substantially affecting thermal transfer.

Electrical component board—A board configured to house a plurality of electrical components, wherein the electrical components are mechanically coupled to the board and electrically coupled to one another. In addition, electrical component boards may mechanically and electrically couple with a bus or receiver unit to facilitate support. An electrical component board may include a mounting structure for normalizing the size of multiple standard printed circuit boards (PCB).

Vertical alignment—A device that is vertically aligned or positioned such that its longest dimension is oriented in a substantially vertical plane or normal to a supporting surface. For example, a telephone pole is aligned vertically.

Plenum—A module for redirecting air flow. In the illustrated embodiments, the plenum is disposed below the electrical component boards.

Audio input device—An electrical device configured to produce audio signals including but not limited to a receiver, tuner, digital media player (CD, DVD, etc), television, computer, gaming console, portable media player, etc.

Audio output device—An electrical device configured to receive and broadcast audio signals in an audible format, including but not limited to speakers, subwoofers, tweeters, headphones, etc.

Video input device—An electrical device configured to produce video signals including but not limited to a cable receiver, tuner, television, computer, gaming console, etc.

Video output device—An electrical device configured to receive and broadcast video signals in a visual format including but not limited to a monitor, television, cell phone, portable media player, etc.

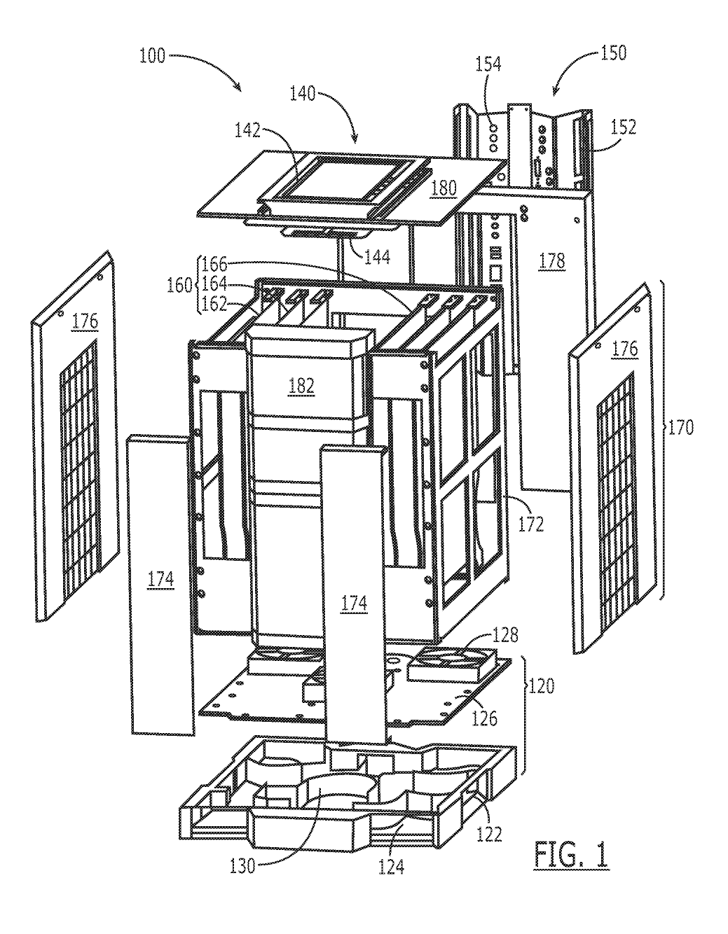

Reference is initially made to FIG. 1, which illustrates an exploded perspective view of a noise containment and vibration isolation system in accordance with one embodiment of the present invention, designated generally at 100. The illustrated system also contains a particular cooling system, which will be described briefly below for reference purposes. The noise containment and vibration isolation systems of the present invention are designed to operate in conjunction with this or other cooling systems to enable proper operation of electrical components. The system 100 includes a set of electrical component boards 160, a plenum 120, an outlet 140, and a housing 170. The illustrated electrical component boards 160 include six boards, three of which are designated respectively as a first, second, and fourth board 162, 164, 166. Various systems may hold as few as two electrical component boards and still incorporate the teachings of the present invention. The illustrated electrical component boards 160 include individual electrical components electrically intercoupled as a conventional printed circuit board to provide audio and/or video functionalities. Each of the electrical component boards 160 may be a conventional audio or video component without its housing, such as a DVD player, game console, DVR, etc. The electrical component boards 160 are also electrically intercoupled with one another to further provide audio and/or video functionalities. The electrical intercoupling of the individual electrical component boards 160 is configured to integrate their functionalities and includes both software and hardware integration. To facilitate the proper air flow, the electrical component boards 160 are oriented vertically with the longest axis oriented perpendicular to the supporting surface. The orientation of the boards 160 is mechanically supported by the housing 170 and more particularly by an internal chassis or racking system 172. The electrical component boards 160 may further include mounting structures so as to ensure consistent shaping among the individual boards. The internal chassis or racking system creates a particular spacing between the boards as illustrated.

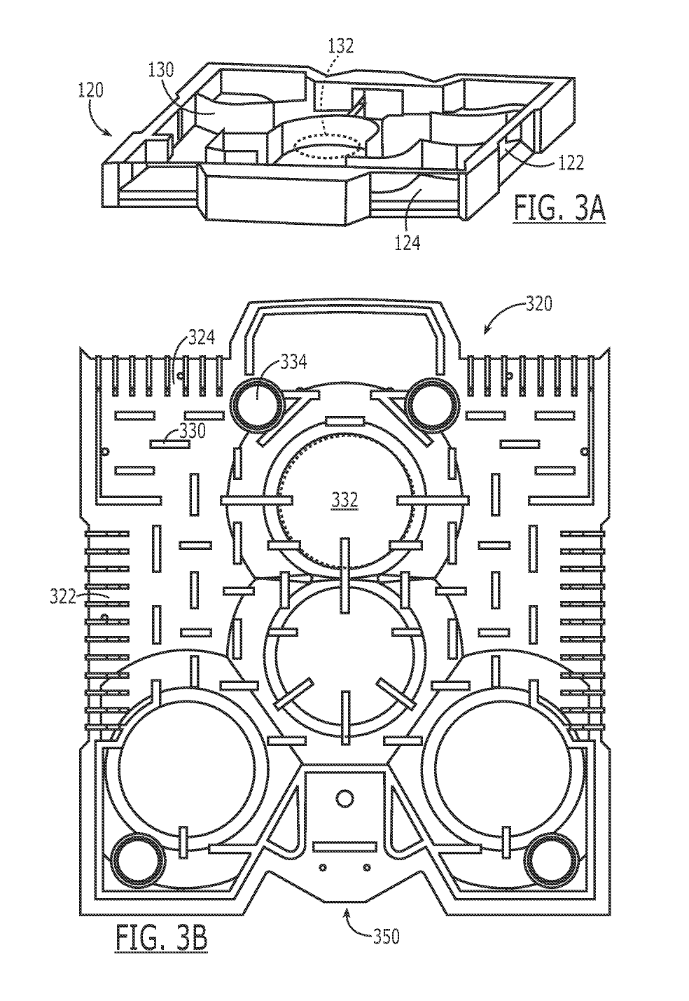

The plenum 120 is disposed below the housing 170 and the electrical component boards 160. The plenum 120 facilitates the intake and directing of ambient air for the cooling system 100. The plenum 120 includes a front inlet 124, a lateral inlet 122, a set of air guides 130, a cover 126, and a set of fans 128. The inlets 122, 124 receive ambient air from the surrounding environment and allow it to enter the system at a location vertically below the electrical component boards 160. This location of air intake is critical in the overall system's ability to utilize the natural process of convection for heat transfer. The set of air guides 130 and cover 126 create independent air flow channels that horizontally direct the air to flow to regions vertically aligned with locations corresponding to between the individual electrical component boards 160. In the illustrated embodiment, these vertically aligned locations correspond to the positioning of the fans 128. It should be noted that the fans 128 enhance the natural convectional based air flow and are optional components. Therefore, even if the fans 128 are removed or malfunction, the system 100 will circulate ambient air through convection alone. In the illustrated embodiment, the fans 128 enhance the air flow by further directing the air vertically from the plenum 120 between the electrical component boards 160. Additional details and description of the plenum 120 and its associated system wide functionality and internal technology will be discussed in reference to FIGS. 3A-3B.

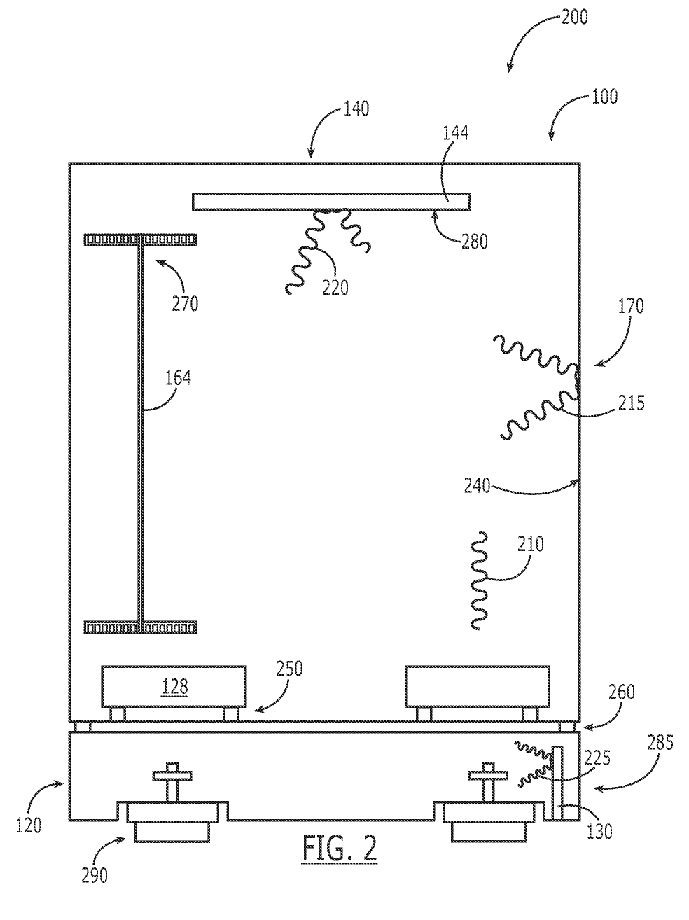

The housing 170 substantially encases and supports the electrical component boards 160 in the vertically oriented configuration illustrated and described above. The region within the housing 170 receives air flow vertically from the plenum 120, allows it to flow vertically around and between the electrical component boards 160 and then exhaust toward the outlet 140. The air flow adjacent to the electrical component boards is naturally heat affected because of the difference in heat between the ambient air received from the plenum 120 and the heat generated by the operation of the electrical component boards 160. To normalize the heat between the two, the heat from the electrical component boards 160 is released, thereby heat affecting the air. This heat affecting process causes the air to rise in both temperature and position, thereby naturally causing the vertical air flow cycle of the system 100 through convection. The air flow cycle will be illustrated and described in more detail with reference to FIGS. 2A-2C.

The housing 170 includes a plurality of panels, a set of front panels 174, a set of side panels 176, a rear panel 178, and a top panel 180. The housing 170 further includes an internal chassis 172, a front console 182, and a rear connection panel 150. The panels 174, 176, 178, 180 mechanically couple to one another and the internal chassis 172 to define an internal region in which the electrical component boards 160 are housed. The encasement of electrical components is well used in the electronics industry for purposes such as dust protection, electrical isolation, and noise dampening. The front console 182 includes various electrical interconnections, human interface modules, and remote control transceiver locations. The rear connection panel 150 provides a plurality of electrical connections for input and output to the electrical component boards 160. The rear connection panel includes a frame 152 and a set of connection ports 154.

The outlet 140 is disposed on the top cover 180 of the housing 170 to facilitate the exhaust of the temperature affected air through convectional heat transfer principles. The outlet 140 is disposed above the electrical component boards 160 and at the apex of the system 100 to enable heated air to naturally rise away from the electrical component boards 160 and exhaust out of the system 100. The outlet 140 includes an internal baffle 144 and an external port 142. The temperature affected air from within the housing will flow both horizontally and vertically around the baffle 144 and out through the external port 144 so as to be recombined with the ambient air, thereby creating an air flow cycle.

Reference is next made to FIG. 2, which illustrates a schematic view of the embodiment illustrated in FIG. 1 further illustrating the noise containment and mechanical isolation systems, designated generally at 200. The system 100 illustrated in FIG. 1 includes a novel noise containment and mechanical isolation system 200 that operates in cooperation with the unique cooling system to effectively minimize noise transmission without substantially diminishing the cooling properties of the system. The noise containment system includes the encasement 240 of the internal region by the plurality of panels (see FIG. 1 174, 176, 178, 180), the outlet baffling 280, and the inlet baffling 285. Noise containment is important in minimizing the propagation of noise between the interior and exterior portions of the system. For example, the fans 128 generate significant audible noise, which is ideally contained within the interior region so as not to affect or interfere with audio noise production by the operation of the electrical component boards 160. The three dimensional positioning and orientation of the panels creates a substantially enclosed inner region within the housing 170. The electrical component boards 160 are positioned within the inner region for various purposes. The encasement 240 also contains noise transmissions as illustrated by noise propagation arrow 215, shown bouncing off of the side panel of the housing 170. Although the noise propagation arrow 215 is shown bouncing of the side panel, it will be appreciated that the actual noise propagation may include transmitting the sound wave in the form of a vibration to the side panel. In order to maintain proper cooling of the internal region, the inlet and outlet 140 are necessary for air flow. In the illustrated embodiment, the inlet is disposed within the plenum 120 and includes a plurality of air guides 130 which effectively baffles the air flow and therefore air-based sound waves. This inlet containment baffling 285 is represented by noise propagation arrow 225. Likewise, the outlet 140 includes an internal baffle 144 that effectively baffles the air flow and therefore air-based sound waves. This outlet containment baffling 280 is represented by noise propagation arrow 220.

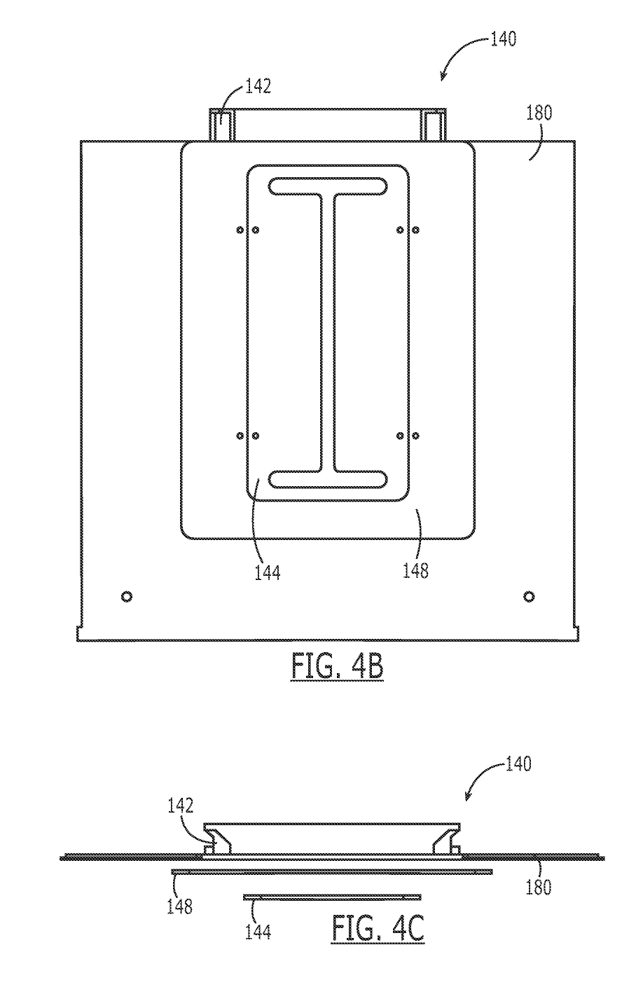

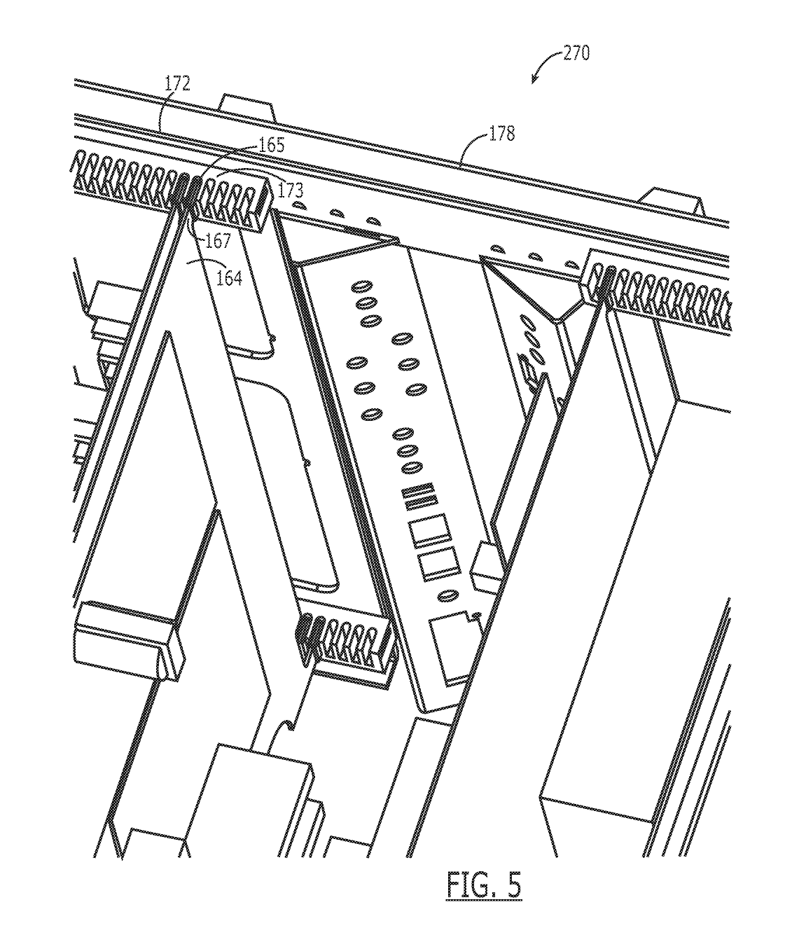

With continued reference to FIG. 2, the illustrated mechanical isolation portion of the system 200 includes electrical component board isolation 270, fan isolation 250, housing-plenum isolation 260, and support surface isolation 290. Mechanical isolation is important in minimizing the vibrational transfer of noise between components of the system. For example, the fans 128 produce significant noise and vibration. By isolating each component from one another, the amount of vibrations imparted onto the electrical component boards 160 are minimized, thereby maximizing performance. The electrical component board isolation 270 includes positioning dampening members between the electrical component board 164 and the chassis of the housing 170. The electrical component boards 160 are coupled to the housing 170 via the chassis 172 to provide mechanical support only. By positioning dampening members at each support coupling, the electrical component boards 160 can be effectively isolated from the housing 170. The electrical component board isolation 270 will be described in more detail with reference to FIG. 5. Fan isolation 250 includes positioning dampening members between the fan 128 and the housing 170, as illustrated. Housing-plenum isolation 260 includes positioning dampening members between the housing 170 and the plenum 120, as illustrated. The support surface isolation 290 includes utilizing a gravitational decoupling scheme in which the weight of the system 100 compresses a dampening member, thereby decoupling the plenum 120 from the coupling member. When the system 100 is lifted during transport, the coupling member gravitationally reengages the plenum 120. The support surface isolation 290 will be described in more detail with reference to FIG. 6.

Reference is next made to FIG. 3A, which illustrates a detailed perspective view of the plenum illustrated in FIG. 1, designated generally at 120. The plenum 120 is comprised of multiple air inlets, including orthogonally positioned front 124 and lateral inlets 122. The orthogonal disposition of the inlets 122, 124 permits increased air flow and ensures that sufficient ambient air is able to enter the plenum 120. Conventional electrical systems often have a single air inlet which may be obstructed depending on the orientation and positioning of the system in relation to walls and other objects. Therefore, the orthogonal disposition of the inlets 122, 124 also creates an air flow intake redundancy. In the illustrated plenum 120, inlets are disposed on three of the four lateral sides to maximize possible air flow. The fourth side of the plenum 120 without an inlet corresponds to the rear of the system and is vertically aligned with the rear connection panel 150 (see FIG. 1). The plenum 120 receives ambient air and directs it to particular vertically aligned locations 132 for optimal heat transfer. The detailed view illustrates the curved nature of the air flow guides 130 designed to minimize resistance. The air flow guides 130 and the cover 126 (not shown) create the channels the direct the air to the vertically aligned locations 132. The vertically aligned locations 132 correspond two-dimensionally to openings in the cover 126 (not shown) and individual fans 128 to permit and enhance vertical air flow in the system 100, respectively. For purposes of noise containment, the air flow guides 130 and resulting channel create the inlet baffling 285 to obstruct direct ambient air transmission within the interior region of the housing 170. The shaping of the air flow guides 130 is specifically selected to balance the air flow principles relating to ambient air circulation and the noise containment principles of the present invention.

Reference is next made to FIG. 3B, which illustrates a detailed elevational view of an alternative plenum, designated generally at 320. The illustrated plenum 320 may function in a sandwich configuration with a mating cover member (not illustrated) that also includes a pattern of corresponding air flow guides and channels. The illustrated plenum 320 includes frontal and lateral inlets 324, 322, numerous air flow guides 330, vertically aligned locations 332, support members 334, and a rear region 350. The plenum 320 is significantly different from the plenum 120 in the shape and nature of the air flow guides 330. It was determined that air flow redirection could be enhanced through the use of numerous small air flow guides 330 versus larger curved air flow guides 130. The air flow guides 330 still function in conjunction with a cover (not illustrated) to create channels that direct air flow toward the vertically aligned locations 332. The inlets 324, 322 include channel members that direct air into the plenum 320 rather than allowing any type of turbulence. In addition, the plenum 120 includes support members 334 for supporting the plenum 320 above a supporting surface. The rear region 350 again corresponds to the rear of the associated system and is vertically aligned with a rear connection panel. The illustrated plenum 320 may be used to replace plenum 120 in the system 100 illustrated in FIG. 1 or may be utilized in an alternative system. For purposes of noise containment, the air flow guides 330 and resulting channel create the inlet baffling 285 to obstruct direct ambient air transmission within the interior region of the housing 170. The shaping of the air flow guides 330 is specifically selected to balance the air flow principles related to ambient air circulation and the noise containment principles of the present invention.

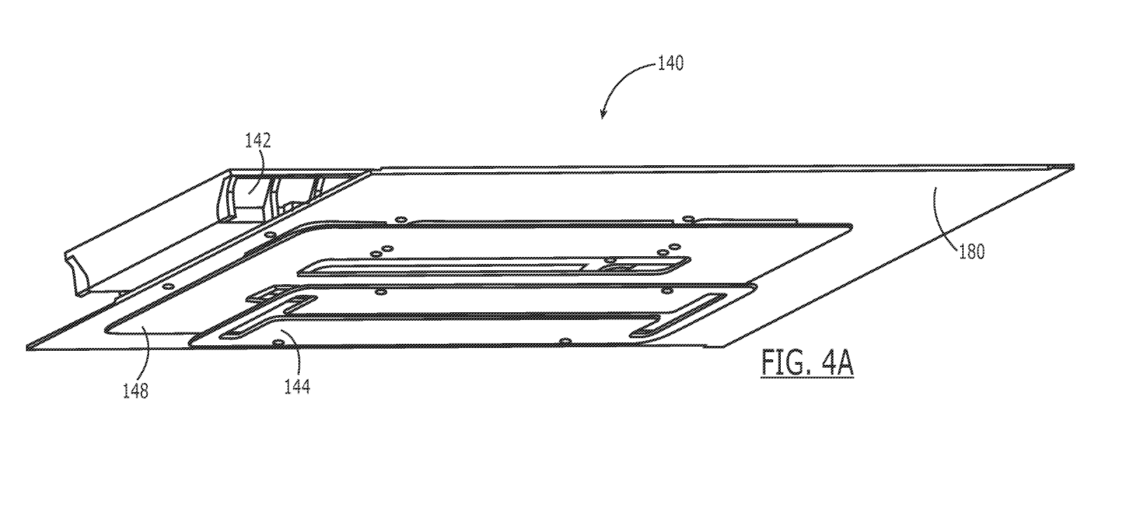

Reference is next made to FIGS. 4A-4C, which illustrate a perspective, profile, and bottom views of an outlet, designated generally at 140. The outlet 140 includes an internal baffle 144, a second internal baffle 148, and an external port 142. The outlet 140 is positioned on the top panel 180 of the housing 170 of the system 100 illustrated in FIG. 1. The internal baffle 144 and second internal baffle 148 baffle ambient air exiting the internal region of the housing. Therefore, the baffles 144, 148 also obstruct air-based transmission of sound waves as part of the noise containment system. The nature of the outlet baffling 280 must also be balanced with the need for ambient air circulation of the system. Various other baffling and outlet designs may be utilized in addition to or in conjunction with the present invention.

Reference is next made to FIG. 5, which illustrates a detailed perspective view of a mechanical isolation of the electrical component boards, designated generally at 270. FIG. 5 is a perspective view of a portion of system 100 showing the second electrical component board 164, a connection tab 167, a dampening sleeve 165, a slotted support member 173, the chassis 172, and the rear panel 178. The second electrical component board 164 includes the connection tab 167 rigidly extending from all four corners (two of which are shown). The connection tabs 167 provide a location at which the second electrical component board 164 may be mechanically supported in the desired configuration. The connection tabs 167 may be composed of a rigid and supportive material similar to the second electrical component board 164, including but not limited to metal and plastic. The dampening sleeves 165 are fitted over the connection tabs 167 at the point of supportive contact, thereby dampening the coupling and isolating the second electrical component member 164 from the housing 170. The dampening sleeves 165 may be composed of a force-absorbing material, including but not limited to rubber and plastic. The connection tabs 167 and the dampening sleeves 165 are fitted within the slotted support member 173 for purposes of mechanical support only. Unlike many conventional electrical component systems, the slotted support member 173 is not an electrical bus of any type. The slotted support member 173 is coupled to the chassis 172, which are correspondingly located in proximity to the rear panel 178 as illustrated.

Reference is next made to FIG. 6, which illustrates a profile view of a support surface isolation system, designated generally at 290. The support surface isolation system 290 includes a rigid coupling member 605, a second dampening member 610, a dampening member 615, and a rigid base member 620. The illustrated system 290 is shown in relation to the plenum 120 in phantom for purposes of contextual illustration. It will be appreciated that the system 290 may be utilized in conjunction with any component to effectuate support surface isolation. The illustrated system 290 is designed to be positioned on the bottom of an electrical system on top of a supportive surface such as the ground. The rigid coupling member 605 is a rigid elongated member with a head portion on top (not designated). The rigid coupling member extends through the plenum 120 and through the dampening member 615 to the rigid base member 620. The rigid coupling member 605 is rigidly coupled to the rigid base member 620 via a coupling including but not limited to a screw and threaded recess type coupling. The head of the rigid coupling member 605 is specifically spaced from the rigid base member 620 and the dampening member 615 so as to provide sufficient space for the plenum 120 and a gap above. The hole in the plenum 120 through which the rigid coupling member 605 is disposed is large enough to minimize contact with the rigid coupling member 605 and may optionally include an internal dampening member. The gravitational weight of the plenum 120 causes it to compress upon the dampening member 615, thereby decoupling the plenum 120 from the rigid coupling member 605. This decoupling, isolates the plenum 120 from the rigid coupling member 605, rigid base member 620, and the corresponding supporting surface upon which the rigid base member 620 is disposed. If the plenum 120 (and associated system 100) are lifted, the gravitational weight of the rigid coupling member 605 will cause it to lower such that the second dampening member 610 engages the top of the plenum 620 for purposes of transportation.

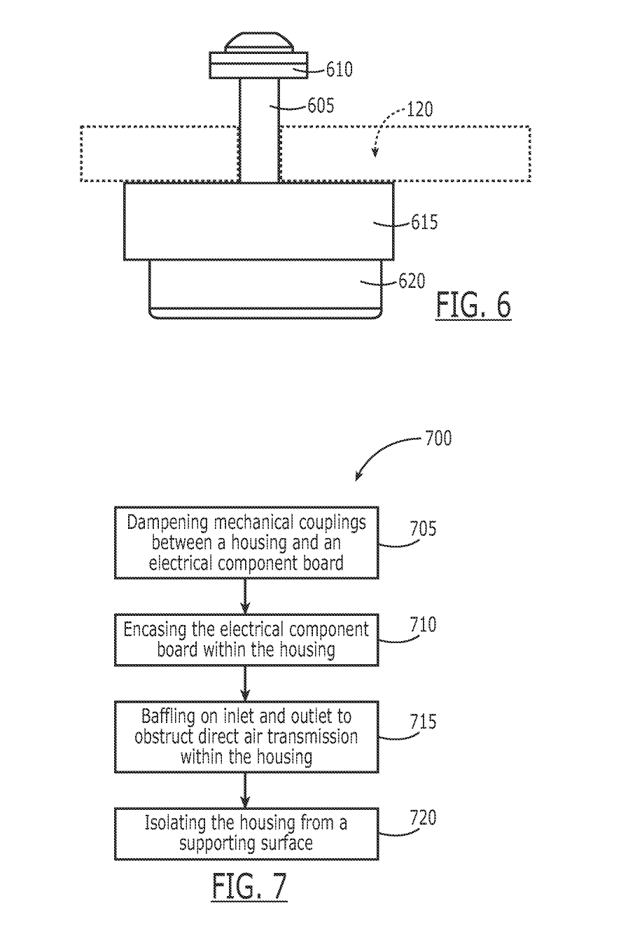

Reference is next made to FIG. 7, which illustrates a flow chart of a method for noise containment and vibration isolation of integrated audio/video electrical components, designated generally at 700. The method includes dampening the mechanical couplings between a housing and an electrical component board, act 705. Encasing the electrical component board within the housing, act 710. Baffling an inlet and outlet to obstruct direct air transmission within the housing, act 715. Isolating the housing from the supporting surface, act 720.

Various other embodiments have been contemplated, including combinations in whole or in part of the embodiments described above.

What is claimed is:

1. A noise containment and vibration isolation system for integrated audio/video electrical components comprising:
at least one electrical component board including a plurality of electrically interconnected components;
a housing configured to mechanically support the at least one electrical component board, wherein the housing includes an internal region in which the at least one electrical component board is disposed;
an inlet configured to receive air into the internal region of the housing;
an outlet configured to exhaust air from the internal region of the housing;
a noise containment system including:
a plurality of panels three dimensionally encasing the at least one electrical component board within the housing such that the internal region is substantially enclosed;
an inlet noise baffle disposed on the housing, wherein the inlet noise baffle obstructs direct ambient air transmission paths within the internal region;
an outlet noise baffle disposed on the housing, wherein the outlet noise baffle obstructs direct ambient air transmission paths within the internal region; and
a mechanical isolation system including:
a plurality of dampening members disposed between the at least one electrical component board and the housing at a plurality of independent locations corresponding to the mechanical support provided by the housing to the at least one electrical component board;
an isolation member disposed between the housing and a support surface, wherein the support surface supports the weight of the system.

2. The system of claim 1, wherein the at least one electrical component board includes at least one of an audio input, video input, audio output, and video output type functionality.

3. The system of claim 1, wherein the at least one electrical component board includes a plurality of electrical component boards oriented in a substantially vertical configuration.

4. The system of claim 1, wherein the inlet is disposed below the at least one electrical component board, and wherein the inlet is disposed on a plenum that further includes a plurality of air guide members that obstruct direct ambient air transmission paths within the internal region.

5. The system of claim 1, wherein the outlet is disposed above the at least one electrical component board and includes an internal baffle member that obstructs direct ambient air transmission paths supported within the internal region.

6. The system of claim 1, wherein each of the plurality of dampening members includes a dampening sleeve disposed on a connection tab extending from the at least one electrical component boards and within a slotted support member of the housing.

7. The system of claim 1, wherein the isolation member includes:
a rigid base member disposed on a supporting surface;
a dampening member disposed above the rigid base member and below a portion of the housing; and
a rigid coupling member extending through the portion of the housing and through the dampening member, and wherein the rigid coupling member is rigidly coupled to the rigid base member.

8. The system of claim 7, wherein the rigid coupling member includes an expanded head region extending above the portion of the housing, and wherein the isolation member further includes a second dampening member above the portion of the housing and below the expanded head region, wherein the rigid coupling member is isolated from the housing as a result of the housing gravitationally compressing the dampening member.

9. The system of claim 1, further including a fan mechanically coupled to the housing at a location corresponding to the inlet, wherein the coupling between housing and the fan includes a dampening member supporting the fan such that the fan is isolated from the housing.

10. The system of claim 1 further including an optically readable media component mechanically coupled to the housing.

11. The system of claim 10, wherein the coupling between the optically readable media component and the housing is aligned with an opening in the housing to facilitate inserting an optically readable media through the housing into the optically readable media component, wherein the opening in the housing is coupled to a releasable covering system, and wherein the releable covering system includes a closed sealed configuration in which the opening is substantially sealed air tight.

12. The system of claim 10, wherein the coupling between the optically readable media component and the housing includes a dampening member supporting the optically readable media component so as to isolate the optically readable media component from the housing.

13. A noise containment and vibration isolation system for integrated audio/video electrical components comprising:
at least one electrical component board including a plurality of electrically interconnected components, wherein the at least one electrical component board includes at least one of an audio input, video input, audio output, and video output type functionality;
a housing configured to mechanically support the at least one electrical component board, wherein the housing includes an internal region in which the at least one electrical component board is disposed;
an inlet configured to receive air into the internal region of the housing;
an outlet configured to exhaust air from the internal region of the housing;
a noise containment system including:
a plurality of panels three dimensionally encasing the at least one electrical component board within the housing such that the internal region is substantially enclosed;
an inlet noise baffle disposed on the housing, wherein the inlet noise baffle obstructs direct ambient air transmission paths within the internal region;
an outlet noise baffle disposed on the housing, wherein the outlet noise baffle obstructs direct ambient air transmission paths within the internal region; and
a mechanical isolation system including:
a plurality of dampening members disposed between the at least one electrical component board and the housing at a plurality of independent locations corresponding to the mechanical support provided by the housing to the at least one electrical component board, wherein each of the plurality of dampening members includes a dampening sleeve disposed on a connection tab extending from the at least one electrical component boards and within a slotted support member of the housing;
an isolation member disposed between the housing and a support surface, wherein the support surface supports the weight of the system, including:
a rigid base member disposed on a supporting surface;
a dampening member disposed above the rigid base member; and
a rigid coupling member extending through a portion of the housing and through the dampening member, and wherein the rigid coupling member is rigidly coupled to the rigid base member.

14. A method for noise containment and vibration isolation of integrated audio/video electrical components comprising the acts of:
providing at least one electrical component board mechanically supported within a housing;
dampening all mechanical couplings between the at least one electrical component board and the housing;
substantially encasing the at least one electrical component board within an internal region of the housing;
providing an air inlet and outlet to facilitate ambient air circulation of the internal region of the housing;
baffling the inlet and outlet to obstruct direct ambient air transmission paths within the internal region; and
isolating the housing from a supporting surface.

15. The method of claim 14, wherein the act of dampening all mechanical couplings between the at least one electrical component board and the housing further includes positioning a dampening member on a connection tab of the at least one electrical component board such that the dampening member is supported within a slotted support member of the housing thereby isolating the at least one electrical component board from the housing.

16. The method of claim 14, wherein the act of substantially encasing the at least one electrical component board within an internal region of the housing includes positioning a plurality of panels on a set of three dimensional sides of the at least one electrical component board.

17. The method of claim 14, wherein the act of baffling the inlet and outlet to obstruct direct ambient air transmission paths within the internal region includes positioning an outlet baffle within the internal region that forces ambient air to wind around the outlet baffle as to flow within the internal region.

18. The method of claim 14, wherein the act of baffling the inlet and outlet to obstruct direct ambient air transmission paths within the internal region includes positioning a plenum below the housing, wherein the inlet is disposed on the housing, and wherein an air passage exists between the internal region and the plenum, and wherein the plenum includes a plurality of air guides that define channels between the inlet and the air passage that forces ambient air to wind around the air guides to flow within the internal region.

19. The method of claim 14, wherein the act of isolating the housing from a supporting surface includes positioning a plurality of isolation members between the housing and the supporting surface including the acts of
extending a rigid coupling member through the housing and through a dampening member such that the dampening member is below the housing; and
coupling a rigid base member to the rigid coupling member at a location below the dampening member.

20. The method of claim 19 including the act of decoupling the housing from the rigid coupling member by gravitationally weighting the dampening member thereby creating a spacing between the rigid coupling member and housing.
